(19) United States
(12) Patent Application Publication
(10) Pub. No.: US 2013/0332079 A1
(43) Pub. Date: Dec. 12, 2013

(54) MONITORING ENVIRONMENTAL CONDITIONS OF AN UNDERWATER INSTALLATION

(71) Applicant: Vetco Gray Controls Limited, Bristol (GB)

(72) Inventors: Gopalakrishna GUDIVADA, Andhra Pradesh (IN); Naresh KUNCHAKOORI, Andhra Pradesh (IN); Steven Lewis SIMPSON, Bristol (GB)

(21) Appl. No.: 13/916,076

(22) Filed: Jun. 12, 2013

(30) Foreign Application Priority Data
Jun. 12, 2012 (EP) 12171694.8

(51) Int. Cl. G01V 1/30; E21B 33/035; G01V 1/40

(52) U.S. Cl. CPC G01V 1/30; G01V 1/40; E21B 33/035
USPC 702/6; 702/14; 166/363

(57) ABSTRACT

An underwater installation comprising at least one underwater control equipment located in a body of water, a plurality of seismic sensors located on a bed of the body of water, wherein the plurality of seismic sensors are configured to monitor conditions to which the at least one underwater control equipment is subjected to, and a processor configured to receive and process data from the plurality of seismic sensors.

### BACKGROUND OF THE INVENTION

Embodiments of the present invention relate to monitoring environmental conditions of an underwater facility, and more specifically a subsea facility.

The effects of shock and vibration which exceed design limits can cause damage or destruction to equipment. Such damage can occur during abnormal operating conditions. It is essential, therefore, that sufficient safety precautions are taken to ensure that equipment is adequately protected against the effects of abnormal shock and vibration.

In oil and gas well production control systems, much of the equipment is installed subsea on the seabed and it is essential that such systems are protected against the effects of shock and vibration caused by extreme conditions, such as those arising due to earthquakes, tsunamis or nuclear explosions. A high level of protection must be built into such systems so that in the event of an incident, the well is shut down before any major damage is done.

The utilization of vibration sensors already fitted with subsea electronics modules (SEMs) to sense shock and vibration conditions transmitted via the seabed, have proved unsatisfactory as the substantial vibrations at the well tree from the fluid extraction process tend to mask the seabed transmitted vibrations and shocks.

### BRIEF DESCRIPTION OF THE INVENTION

According to an embodiment of the present invention, an underwater installation is provided. The underwater installation comprises underwater control equipment located in a body of water, a plurality of seismic sensors located on the bed of the body of water for monitoring conditions to which the equipment is subject, and a processor configured to receive and process data from the seismic sensors. In some embodiments, said equipment is located on said bed of the body of water.

According to an embodiment, the installation could be a well facility, wherein the equipment comprises control equipment for the facility. In this case, said equipment may comprise a tree of the well facility, wherein the processor could comprise an electronics module of a control module of the tree.

According to an embodiment, the installation comprises a well facility, said processor could be configured to cause the well to be shut down in response to given conditions to which said equipment is subject.

According to an embodiment of the present invention, a method of monitoring environmental conditions of an underwater installation is provided. The method comprises underwater control equipment located in a body of water, comprising providing a plurality of seismic sensors located on the bed of the body of water to monitor conditions to which the equipment is subject and receiving and processing data from the sensors.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

FIG. 1 is a schematic diagram of an installation according to an embodiment of the present invention; and

FIG. 2 shows schematically seismic sensors around a tree of the installation according to an embodiment of the present invention.

### DETAILED DESCRIPTION OF THE EXEMPLARY EMBODIMENTS OF THE INVENTION

An embodiment of the present invention involves the deployment and installation of seismic sensors at strategic positions on the seabed adjacent to subsea equipment (for example a Christmas tree) to collect shock and vibration data to which the subsea equipment will be subjected in the event of abnormal conditions. This data can then be collected and transmitted to and processed in a subsea electronics module (SEM). A decision can be made in the SEM to shut down the well should predetermined parameters be exceeded without the need to transmit the data topside and await a shutdown decision. This approach will reduce the system shutdown time. Where appropriate, the sensors can be deployed remotely surrounding an oil or gas field to gather field seismic data and protect all subsea equipment associated with the field.

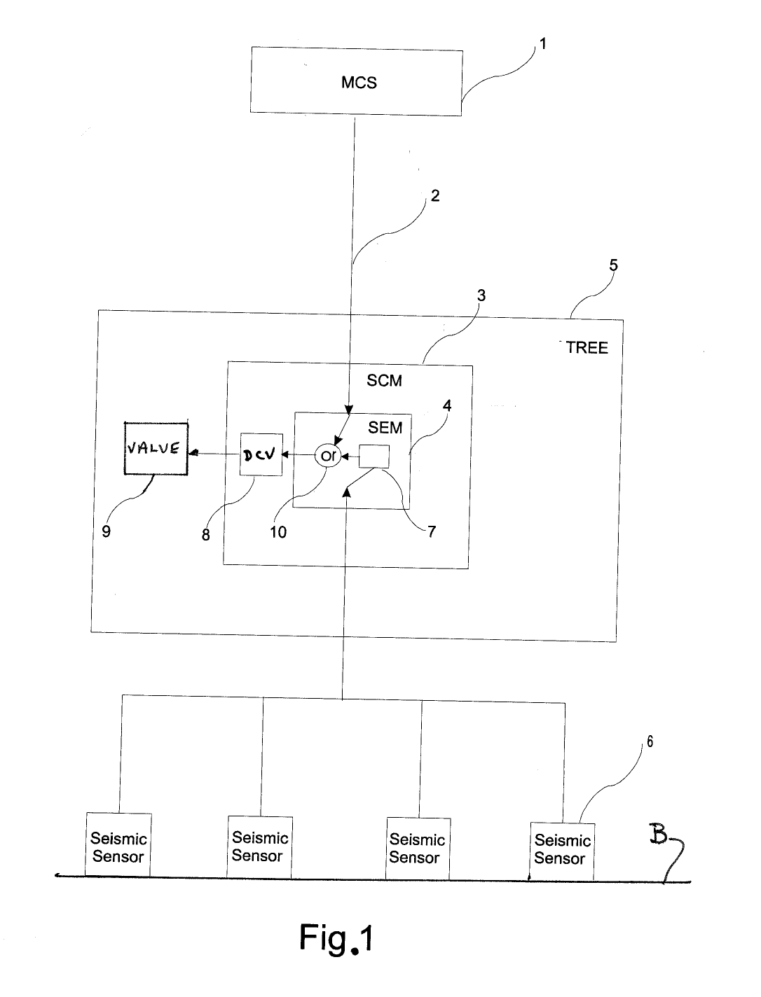

Referring to FIG. 1, the main components which make up a typical production control system in a subsea hydrocarbon production well facility comprises a master control station (MCS) 1, which provides the operator interface with subsea equipment and displays the current state of various items of the equipment, subsea valves and sensor information, enabling the operator to control the system. The main components which make up a typical production control system in a subsea hydrocarbon production well facility may further comprise an umbilical cable 2, which connects the MCS 1 to the subsea equipment installed on the seabed and incorporates a communication link which carries control signals to the equipment and transfers status information to the MCS 1 and a subsea control module (SCM) 3 which receives commands from the MCS 1 and controls all the subsea processes, provides the hydraulic power to actuate valves and transmits status data to the MCS 1. The main components which make up a typical production control system in a subsea hydrocarbon production well facility may further comprise a subsea electronics module (SEM) 4, housed within the SCM 3 and which is a microprocessor based electronics unit that houses a set of printed circuit boards. The functions of the SEM 4 may include communication with the MCS 1 (receiving control information from, and transmitting sensor data to the MCS 1), interfacing with subsurface sensors, and controlling valves and hydraulics. The main components which make up a typical production control system in a subsea hydrocarbon production well facility may further comprise a Christmas tree 5 installed on the seabed, to which the SCM 3 is fitted, housing the SEM 4, and providing the subsurface electric and hydraulic equipment needed to control the flow of fluid from the well.

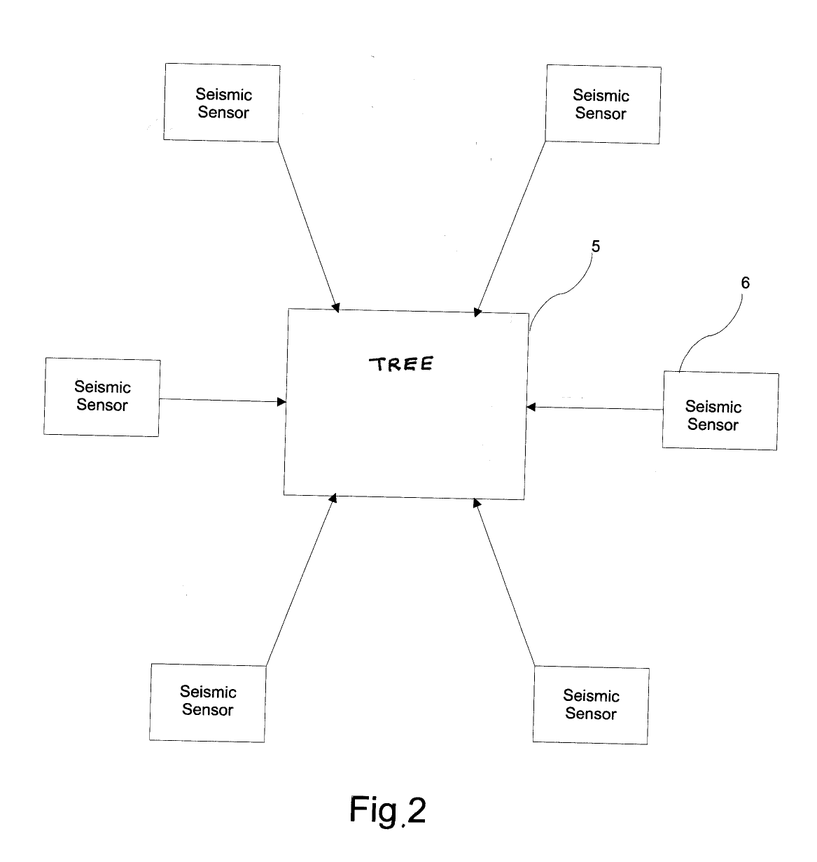

According to an embodiment of the present invention, a set of seismic sensors 6 are installed, external to the equipment to be protected (such as a Christmas tree) and strategically placed around the subsea equipment as shown in FIG. 2 to collect data on the shock and vibration levels being transmitted through the seabed towards the subsea equipment.

According to an embodiment of the present invention, the seismic sensors 6 transmit the shock and vibration data to the SEM 4 as shown in FIG. 1, which can be a microprocessor based unit and may comprise a decision making process 7, by software control of a processor of the SEM. Thus, if process 7 detects that predetermined levels of shock and/or vibration stored within the processor are exceeded, the SEM 4 outputs control of hydraulic directional control valves (DCVs) 8 within the SCM 3, which operate production fluid flow control valves 9 to shut down the well, without recourse to the MCS 1, only one DCV 8 and one valve 9 being shown for simplicity. According to the embodiment, the system shutdown time can be significantly reduced in the event of the shock and/or vibration limits being exceeded, because the sensing, decision and shutdown processes are in a local closed loop. Operation of well shut down, via the surface MCS 1, remains an alternative option as illustrated by the ‘or’ function 10.

Embodiments of the present invention enable reduction or prevention of major damage to systems and equipment by a fast shutdown capability by the independence from surface control and enable a fast return to an operational state once the shock and/or vibration levels have returned to normal. Embodiments of the present invention would also be useful in other subsea applications, such as subsea drilling control systems and production systems. Reduced damage caused by shock and/or vibration results in reduced maintenance and repair costs and also in less loss of revenue due to shutdowns. Improved protection against major catastrophes and abnormal operating conditions reduces the risk of loss of hydrocarbon fuel, environmental pollution and its inherent removal costs. Embodiments of the present invention provide valuable information for preventative maintenance systems.

Thus, while there has been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An underwater installation comprising:
at least one underwater control equipment located in a body of water;
a plurality of seismic sensors located on a bed of the body of water wherein the plurality of seismic sensors are configured to monitor conditions to which the at least one underwater control equipment is subjected to; and
a processor configured to receive and process data from the plurality of seismic sensors.

2. The underwater installation according to claim 1, wherein the at least one underwater control equipment is located on the bed of the body of water.

3. The underwater installation according to claim 1, wherein the underwater installation is a well facility, and the at least one underwater control equipment comprises a control equipment for the well facility.

4. The underwater installation according to claim 3, wherein the at least one underwater control equipment comprises a tree of the well facility.

5. The underwater installation according to claim 4, wherein the processor comprises an electronics module of a control module of the tree.

6. The underwater installation according to claim 3, wherein the processor is further configured to shut down the well facility in response to at least one predetermined condition of the conditions to which the at least one underwater control equipment is subjected to.

7. The underwater installation according to claim 3, wherein the well facility is a hydrocarbon production well facility.

8. An underwater installation comprising:
at least one underwater control equipment located in a body of water;
a plurality of seismic sensors located on a bed of the body of water wherein the plurality of seismic sensors are configured to monitor conditions to which the at least one underwater control equipment is subjected to; and
a processor configured to receive and process data from the plurality of seismic sensors, wherein:
the at least one underwater control equipment is located on the bed of the body of water,
the underwater installation is a well facility, wherein the at least one underwater control equipment comprises a control equipment for the well facility,
the at least one underwater control equipment comprises a tree of the well facility,
the processor comprises an electronic module of a control module of the tree, and
the processor is further configured to shut down the well facility in response to at least one predetermined condition of the conditions to which the at least one underwater control equipment is subjected to.

9. A method of monitoring environmental conditions of an underwater installation comprising at least one underwater control equipment located in a body of water, the method comprising:
providing a plurality of seismic sensors located on a bed of the body of water, wherein the plurality of seismic sensors is configured to monitor conditions to which the at least one underwater control equipment is subjected to; and
receiving and processing data from the plurality of seismic sensors.

10. The method according to claim 9, wherein the at least one underwater control equipment is located on the bed of the body of water.

11. The method according to claim 9, wherein the installation is a well facility and the at least one underwater control equipment comprises a control equipment for the well facility.

12. The method according to claim 11, wherein the at least one underwater control equipment comprises a tree of the well facility.

13. The method according to claim 12, wherein receiving and processing data comprises receiving and processing data by an electronic module of a control module of the tree.

14. The method according to claim 11, wherein at least one of the received and processed data is indicative of at least one predetermined condition of the conditions to which the at least one underwater control equipment is subjected to, the method further comprising shutting down the well facility in response to the at least one received and processed data.

15. The method according to claim 11, wherein the well facility is a hydrocarbon production well facility.
